(19) United States
(12) Patent Application Publication
(10) Pub. No.: US 2025/0078006 A1
(43) Pub. Date: Mar. 6, 2025

(54) SYSTEM AND METHOD FOR SEMANTIC GLOSSARY-DRIVEN BUSINESS CONCEPTUAL MODELING (SGDCM)

(71) Applicant: Metaware LLC, Cary, NC (US)

(72) Inventor: Kishore Venugopalan, Cary, NC (US)

(21) Appl. No.: 18/821,254

(22) Filed: Aug. 30, 2024

Related U.S. Application Data
(60) Provisional application No. 63/579,790, filed on Aug. 30, 2023.

(51) Int. Cl. G06Q 10/0637; G06Q 10/067

(52) U.S. Cl. CPC G06Q 10/06375; G06Q 10/067

(57) ABSTRACT

The embodiments herein are directed to a system and method for business data mapping which are characterized by the use of denormalized metadata. The system and method operate upon heterogeneous data sets in comparison to one or more business-specific glossaries. The returned data sets are characterized by adherence to business goals, and are dynamically available to an end-user with little to no specialized coding infrastructure.

### CROSS-REFERENCE TO RELATED APPLICATION

This application claims the benefit of U.S. Provisional Application No. 63/579,790, filed Aug. 30, 2023 and entitled “System and Method for Source-denormalized Data Winnowing”.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Traditional data management practices, characterized by centralized IT ownership and complex ETL (Extract, Transform, Load) pipelines, often struggle to keep pace with the dynamic needs of modern businesses. These approaches tend to marginalize business teams, limiting their involvement in crucial data initiatives. This disconnect often results in data models that fail to fully reflect business requirements, leading to inefficiencies, data silos, and missed opportunities for insight-driven decision-making.

Furthermore, the manual mapping of business terminology to underlying data sources is a time-consuming and error-prone process. As data volumes and complexity increase, these challenges are exacerbated, hindering scalability and agility.

These limitations highlight the need for a more innovative and user-centric approach to data management. One that empowers business teams, fosters collaboration, and seamlessly bridges the gap between business concepts and their technical implementation.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a process flow diagram of the Business Conceptual Model creation elements consistent with certain embodiments of the present invention.

FIG. 2 is a process flow diagram of the transformation data engine Architecture consistent with certain embodiments of the present invention.

FIG. 3 is a component diagram indicating the different components involved in creation of the Business Conceptual Model consistent with certain embodiments of the present invention.

FIG. 4 is a services diagram of the Bridge Exchange Mesh (BMX) consistent with certain embodiments of the present invention.

FIG. 5 is a system architecture diagram of the data platform, data governance and reporting consistent with certain embodiments of the present invention.

FIG. 6 is a mapping diagram of the hybrid data mesh benefits consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

It is noted in particular that where a range of values is provided in this specification, each value between the upper and lower limits of that range is also specifically disclosed. The upper and lower limits of these smaller ranges may independently be included or excluded in the range as well.

The field of the instant innovation is the area of business metadata, data analysis, data wrangling, data storage (staging), Extract-Transform and Load (ETL) processes, and data warehousing.

In an embodiment, the instant innovation empowers business teams to independently drive their data management and governance with tools for analysis, reporting, and modeling. This autonomy enables faster, data-driven decisions while promoting ownership and accountability for their data as a product.

The instant innovation generates staging or raw data, reference data and business conceptual models processed data into one or more Embedded, file-based RDBMS files that become part of the broader file system or a part of a data lake. The processed data is generated as tables or temporary tables as needed into proper buckets namely namespaces, subject areas, entity and meta example, (namespace) finance, (subject area) security, (entity) security value, (meta) local price OR (namespace) staging, (subject area) SEC, (entity) security, (meta) currency. The source of the data to be processed can be internal or external source; in a non-limiting example, the data comes in a raw form from an external vendor.

The instant innovation contains the following key components
Governance and Business Portal (GBP): A self-service platform that empowers business users to define and manage glossaries, data sources, business rules, and data quality checks.
Semantic Meta Generation Engine (SME): Transforms business logic into a structured Semantic Layer, bridging business concepts and their technical implementations.
Business Conceptual Model Generation Engine (BCME): Creates the Business Conceptual Model (BCM), representing business logic and entities as database tables.
Business Conceptual Model (BCM): A visual and database representation of core entities, processes, and their interconnections within a specific business domain.
Semantic Layer: An abstraction layer that stores business metadata and rules, linking business concepts (glossary terms) to their technical implementation in data sources.
Bridge Exchange Mesh (BXM): A hybrid data mesh that combines decentralized domain ownership with centralized governance, leveraging business glossaries to drive conceptual modeling and promote collaboration.

The metadata for the conceptual model of the instant innovation is generated based on a business glossary, source data, business rules, data quality rules collected early in the business data capturing process using the Governance and Business Portal (GBP). Only selected or limited data points with the business glossary are used to create the model as determined by the business requirement or use case of the end user. The business glossary is collected as a part of early workflows in documenting the business data points and business flows. The Business Glossary is an important piece of putting together the data points within the conceptual model and thus providing the data lineage of connecting all the relevant meta together. Currently, business teams often play a passive role in data initiatives, resulting in disconnected efforts and limited involvement in data management.

Metaware's Bridge Data Mesh (BXM) is a collaborative approach to data management. It empowers business teams to define and own their data domains using a self-service portal, where they can focus on creating business glossaries, connecting to data sources, ensuring data quality, and developing business-centric conceptual models.

With BXM, business teams contribute high-quality data and insights, reducing their reliance on centralized IT teams and enabling them to focus on more strategic and technically challenging initiatives such as data mastering, cloud security, API development, data mart, operation data store and infrastructure management. This clear separation of responsibilities fosters greater efficiency and collaboration, allowing each team to leverage its expertise effectively.

Metaware enables business users to manage their business metadata, analyze data, and derive insights through the use of business conceptual models. Technology teams then utilize these models to drive the creation and maintenance of physical models in their operational data stores or data marts. This process significantly reduces the effort required by technology teams, thanks to the high-quality data provided by the business conceptual models. This approach adheres to the core principle of data mesh-domain ownership-while preventing the formation of isolated data silos.

Semantic Glossary-Driven Conceptual Modeling (SGDCM) primarily leverages the business glossary as the foundation for creating the underlying business model. This user-centric approach eliminates the traditional reliance on complex extract, transform, load (ETL) pipelines, replacing them with streamlined business workflows.

At its core, the Semantic Glossary-Driven Business Conceptual Modeling (SGDCM), system intelligently interprets the semantic meaning of glossary terms and their interconnections by embedding them in a semantic layer and then using the semantic layer to create and load the business model. Metaware dynamically generates conceptual business models based on the glossary definitions, interconnections, and linked data sources.

The SEMANTIC LAYER is crucial for the implementation of Semantic Glossary-Driven Conceptual Modeling (SGDCM) for interpreting and storing the business data in a way that can be used to create the business conceptual model. This layer will include the following data:
1. Business Glossaries: Define business terms, synonyms, descriptions, data types, and hierarchical or associative relationships between terms, ensuring a shared understanding of the business domain.
2. Data Sources: Define and Connect to various data sources, including CSV files, databases (relational and NoSQL), APIs, real-time data streams, and internal systems, providing a holistic view of the data landscape, be it external or internal sources.
3. Granularity and Unique Keys: Specify the level of detail (granularity) for each data source and identify the natural or unique keys that uniquely identify records within that granularity, ensuring data integrity and consistency.
4. Data Quality Rules: Checks for data integrity and validity to ensure data accuracy, completeness, and compliance with business requirements such as verifying SSN formats or data type correctness.
5. Business Rules and Transformations: Essential transformations for source data, into proprietary business logic for that division.
6. Data Standardization Rules: Ensures uniformity across data sources, such as mapping country names to ISO standard codes.

The Semantic Meta Generation Engine (SME) acts as a crucial bridge, converting business logic, data quality rules, and data standardization rules into a SQL abstraction layer, effectively decoupling business concepts from their technical implementation. This layer serves as a business metadata repository, capturing inputs from business analysts throughout the process and enabling an ELT (Extract, Load, Transform) architecture to efficiently populate business models.

This dynamic creation of business conceptual model means business has less headache in terms of deployment, maintenance and versioning of the data structures but rather focus on validating and analyzing their business model.

Currently establishing connections between business terminology and underlying data sources typically requires manual mapping and complex integration processes-methods that are time-consuming, error-prone, and challenging to scale as data volumes grow. Metaware links glossary terms to business rules defined on the source data and creates an innovative semantic layer that bridges the gap between business concepts and their technical implementation. This dynamic linkage provides the foundation for automated business model generation, enabling organizations to rapidly adapt to changing business requirements and unlock the full potential of their data assets. However, complex data mapping requires deriving the desired granularity using a multi-step transformation before mapping to the glossary.

The semantic layer design is intended to leverage views or macros for technical flexibility, while also accommodating application code written in Python and similar languages, by converting them into SQL macros for seamless integration.

Additionally, data sources may contain embedded granularity, such as a position including both account and security grains. Deriving the specific granularity may require a multi-step transformation process before linking to the glossary. Embedded databases may lack procedural structures for deriving the specific granularity, so this instant innovation plans to leverage Common Table Expressions (CTEs) or application language macros to execute these multi-step transformations effectively within these databases.

These multi-step transformations create temporary tables at various levels or sequences, progressively refining data to achieve the desired granularity. This innovation will leverage CTEs for managing and debugging these transformation stages, as each step encapsulates the previous one. In Metaware, CTEs are part of a broader framework called “tidbits,” which can also incorporate application logic, such as Python functions or scripts, for handling more complex transformations.

The semantic layer integrates source data from various origins into a business conceptual model within the embedded database. Depending on the scenario, data can remain as virtual tables (lazy loading) or be materialized into physical tables, particularly for consolidating delta files.

Unlike traditional ETL or ELT vendors which often require complex transformation pipelines and specialized technical skills, MetaWare simplifies the process by offering streamlined workflows that empower domain owners to directly manage and model their data. This user-centric approach results in faster development cycles and reduced errors.

Furthermore, unlike traditional ETL platforms, which are complex, require high expertise, and have longer development cycles, Metaware simplifies data processing with easy-to-manage workflows, reduces the risk of vendor lock-in by offering less technology debt with an accessible data lake and business metadata, and actively integrates the glossary into data operations, directly driving business models and reporting processes. The glossary actively drives the creation of the business conceptual model, transforming it from a passive reference into an essential, dynamic component of the data management process.

The SGBCM process is installed within a data processor receiving a plurality of data files from a plurality of data sources internal and external to said data processor. The data processor receives a set of source data rules for data management from a Subject Matter Expert (SME), and a business glossary of customized data definitions from the SME. The data processor, under direction of the SME, links the received source data rules to the business glossary and permits the SGBCM process module to create a business conceptual model where the business conceptual module guides the data analysis of said plurality of data files. Additionally, the SGBCM process module derives business operation insights from the data analysis, and the data processor utilizes the derived business operation insights to optimize business governance methods and optimize services provided to clients of the business.

In an embodiment, only data important to the specific needs of a business is executed upon from the business glossary into a business conceptual model. As used herein, a Data Warehouse is an electronic storage apparatus arrayed as a vertical store of data. As used herein, a Data Lake is an electronic storage apparatus arrayed as a horizontal store of data.

Any Data Warehouse implementation will mostly be physical model that are typically used in an operational data store or a data warehouse implementation and is usually horizontally scaled and the data structure of the instant innovation, BCM, may be completely independent structures and not correlated. In an embodiment, a BCM Electronic Storage Apparatus stores data horizontally, similar to a Data Lake, across embedded databases.

Business exchange mesh (BXM) is a framework that contains multiple business team meshes each segregated from each other like finance mesh or sales mesh etc. In that context there could be multiple Business conceptual model (BCM) and within each Business conceptual model (BCM) the model and source data can be placed in clusters of date folders, using business dates or as-of dates. There will be an active cluster and historical clusters separated by business as-of dates for each data mesh. Though the historical clusters can carry different metadata or different versions of the same entity, they form an integral part of the data lake and can be read based on the metadata associated at that point in time.

The commercial viability and the advantages of this approach are numerous:
1. Self-Service Platform with simplified workflows: Simplifies data management for business users and domain owners, empowering them to control their data without IT support.
2. Faster Insights: Enables quicker report generation and analytics, reducing the time-to-insight from months to weeks.
3. Enhanced Collaboration: Promotes teamwork between business and data engineering teams, improving data quality and model accuracy.
4. Optimal Performance: Advanced ELT mechanisms leverage database server power, ensuring efficient, fast data processing.
5. Reduced Complexity: Low-code platform with SQL rules and flexible programming language support minimizes code complexity.
6. Improved Fault Tolerance: Isolated transformations and horizontal data distribution enhance application reliability.
7. Agile data management: The streamlined workflows and the separation of responsibilities between technology and business teams forces teams to follow an agile approach instead of a traditional waterfall.

Future directions for development may include-
1. Lightweight Desktop App: Develop a user-friendly desktop application for offline data querying and report generation.
2. Dynamic ORM Stub Generation for developers: Automatically create ORM stubs to facilitate an application interface for querying business models.
3. Simplified Data Access with GraphQL: Provide an easy-to-use GraphQL interface for business units and IT to access and utilize data efficiently.
4. Pre-built models—Empowering business teams to fast-track their initiatives using existing proven standards.

In an embodiment, the instant innovation makes data wrangling or data ingestion for business operations and needs simple for even a novice user, eliminating the need for intensive technological know-how in order to define, understand and get insights into business data that has been normalized into a form suitable for storage in a Data Warehouse.

In an embodiment, the instant innovation uses an agile and disciplined process requiring little or no code to dynamically create one or data models using business metadata. The instant innovation permits a user to experiment with and explore the one or more data models, for a given business pain point, until the user applies his learnings, data quality and incorporating business rules, to perfect the model gradually to the point of using them in a real production scenario.

The agility of the instant innovation permits the system and process to dynamically improve upon imperfect initial models by making multiple iterations or having multiple models, rather than rigid models that are inherently common in most businesses and becomes a blockade by itself. A business user may employ such agility to start analyzing data himself rather than waiting on technology teams to create a model thought to be perfect.

In an embodiment, the instant innovation forms the foundation for a physical model such as, but not limited to, Online Transactional Processing (OLTP), Operational Data Store (ODS), Data Hub, and/or Data Mart.

In an embodiment, the instant innovation has the capability to use a pre-built data model based on previous learnings in a specified functional area, and one that can be ported from one organization to another.

In an embodiment, the pre-built business data models created though learning and refinement process across multiple organizations can be used to create “standardized business models” for each domain including, but not limited to, finance; health care; and environmental, social, governance (ESG). Along with business metadata, the resulting standardized business models can be easily ported from one organization to another. In this context, each model can be defined as a universal business model (or pre-built model) that can be re-used by multiple organizations for the same domain.

In an embodiment, the instant innovation conceptually stores model history horizontally rather than vertically and uses natural key association more than surrogate keys, which are ancillary to, rather than the primary drivers of, any resulting physical model. Each entity is assigned a granularity that uniquely identifies it. For example, staging.cms.physician_payment might have a granularity of healthcare.finance.payment. Subsequently, the unique keys within the entity that define this granularity, or the natural key, are identified. In this example, the natural key could be the combination of payment_date and physician_id.

When the desired granularity for a source involves transformation, whether it's a single step or multiple, it's achieved through a series of temporary tables or steps known as “tidbits.” Each tidbit represents a specific piece of information contributing to the final granularity. For instance, if an “account” granularity needs to be derived from a “position” file containing account data, this can be done using an “aggregation” tidbit or a “Python script” tidbit, ultimately transforming the data to the intended granularity.

In an embodiment, the rules created in the transformation widget may be expressions or statements like, by way of non-limiting example, r1=s1+s2 or r2=function (s3, s4), primarily based on the source metadata.

In an embodiment, the business glossary is used in creating the columns within the model (or namespace type that is “model”). This is essentially a constraint for namespace with type=“model” that can only derive columns that are defined within the glossary.

Namespaces serve various functions, including:
“staging”: Houses raw, unprocessed data from external sources.
“model”: Contains business conceptual models derived from the glossary.
“reference”: Stores standardized data like ISO codes.
“glossary”: Holds division-wide definitions and standards.

Namespaces also represent organizational divisions like finance, sales, or HR, providing self-containment and enabling granular access control at the divisional level.

In an embodiment, the business glossary is derived as a part of the metadata collection that happens in the initial phases of the business process analysis, mostly conducted by a business analyst. The business glossary identifies several data points within the business flows (or workflows) that are currently in place within a firm or planned for a future firm project. By way of non-limiting example, a “finance namespace glossary” can contain elements like “market_value,” “net_exposure,” or “gross_exposure” which elements are commonly defined by the business or a business analyst during the initial phases of the project.

In an embodiment, the business glossary forms an important aspect in the creation of models later on in the process. The business glossary can also be exported from pre-built functional area glossaries, for example, for finance or health care, among many other topics, based at least in part on the maturity of the firm in those respective areas of engagement with the several organizations. Pre-built function area glossaries, however, are not typically available immediately in the initial phases of the product but instead are gradually developed as the product matures.

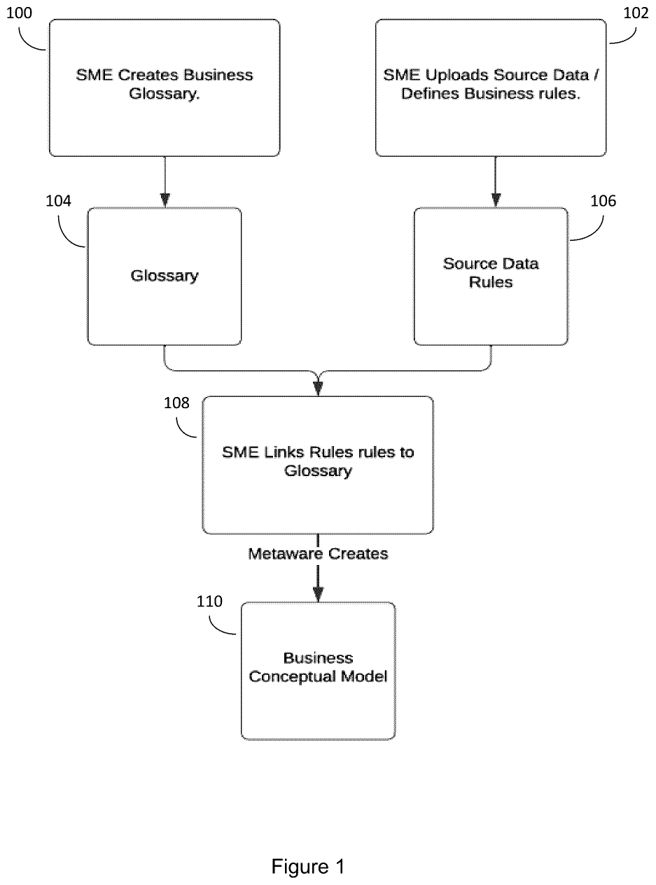

Turning now to FIG. 1, a process flow diagram of the Business Conceptual Model consistent with certain embodiments of the present invention is shown. Shown left to right are characteristics inherent to the instant innovation including: the availability of ETL for novice users; the quality of being metadata-driven; the quality of requiring low or no code to implement; and the qualities of being dynamic, offering rapid analytics, and being horizontally scaled.

At 100 a Subject Matter Expert (SME) may create a business glossary that represents input from documented business processes that are in use or to be optimized. At 102, the SME may simultaneously upload source data to be used and defines the business logic or rules against the source that will be used in controlling the generation of a business model. At 104 the Business Glossary is instantiated as a working document, stored and maintained in an electronic storage device. At 106, the Source Data Rules are saved to an electronic storage device for later retrieval and use. At 108, the SME causes the Glossary to be linked to the Source Data rules and passes the linked information to a Meta-ware algorithm that creates the Business Conceptual Model at 110. Distinctly, the SME may collect metadata from customer-centric data sources for subsequent mapping to populate the Business Conceptual Model.

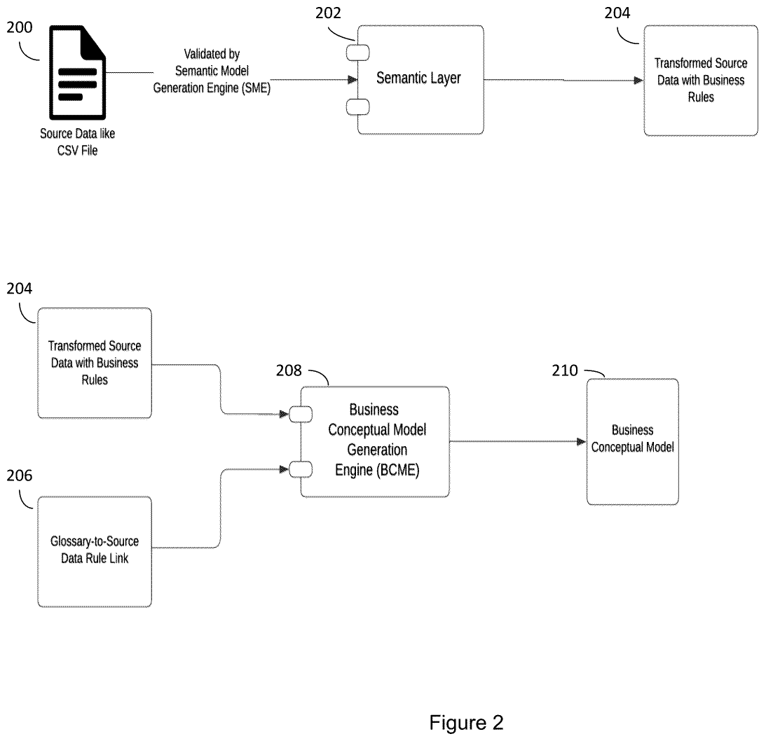

Turning now to FIG. 2, presents a process flow diagram of the Meta-ware Transformation Data Engine Architecture consistent with certain embodiments of the present invention is shown. In an embodiment, the entirety of the Data Architecture of the instant innovation is housed within a Cloud ecosystem.

At 200 source data for each business is imported in one or more data formats, such as, in a non-limiting example, a Comma Separated Variable (CSV) format. Other data formats may be used to import additional source data. The input data will be validated by a Semantic Meta Generation Engine (SME) to ensure confidence in the authenticity and formatting of the incoming source data and the validated business meta and rules are stored in the Semantic Layer at 202. The Semantic Layer 202 applies the business rules input to the system by the SME and the transformed business data is transferred to electronic storage as source data that has been transformed to a different format and data structure by applying the business rules.

The transformed source data 204 and a Glossary-to-Source data rule link 206 are input to the Business Conceptual Model Generation Engine (BCME). Data is received from sources both internal and external to the business consumer and stored into a staging layer that is part of the data lake. The BCME system pulls data from the staging layer and creates the business conceptual model which becomes the basis for implementing data analytics, data mastering, data quality determination and data governance. The resulting BCM output is sent to segregated components depending upon the immediate actionability of the data: for actively used data, such as the most recent data value for a particular data element or structure, the output may be sent to reside within a Data Hub that is maintained by the centralized data team. For other data, such as historical segments for the same data values captured over time and through other operations, the output may be sent to reside within a Data Mart to be stored until called upon, again maintained by the centralized data team. The BCME takes the source data and the data rule link as input to the algorithm to build the Business Conceptual Model 210 and stores the BCM into a model database maintained in an electronic storage system.

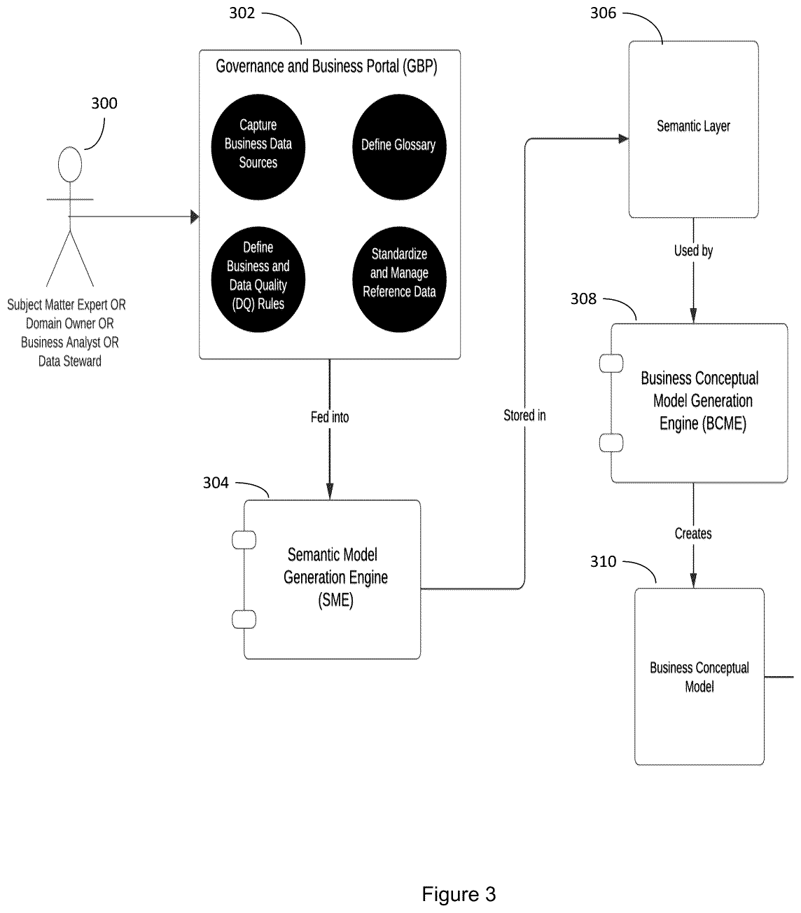

Turning now to FIG. 3, presents component diagram indicating the different components involved in creation of the Business Conceptual Model consistent with certain embodiments of the present invention is shown. At 300 a user having the credentials to supply business metadata and business rules such as, in non-limiting examples, a Subject Matter Expert (SME), Domain Owner, Business Analyst, or Data Steward, presents guidance and commands to the Governance and Business Portal (GBP). At 302 the GBP is a module active to capture business data sources, defining a business Glossary, defining the Business and Data Quality rules, and standardizes and manages reference data received. The GBP transfers the information, glossary, and metadata to the Semantic Meta Generation Engine (SME) at 304.

The SME adapts the data to reformat the information and rules received from the human user and stores the transformed data and other information into a semantic layer model in an electronic database at 306. The Semantic Layer at 306 holds the transformed data and other information until the transformed data and other information is requested for use in creating a BCM by the BCME at 308. The BCME utilizes the data and other information received to create the Business Conceptual Model at 310.

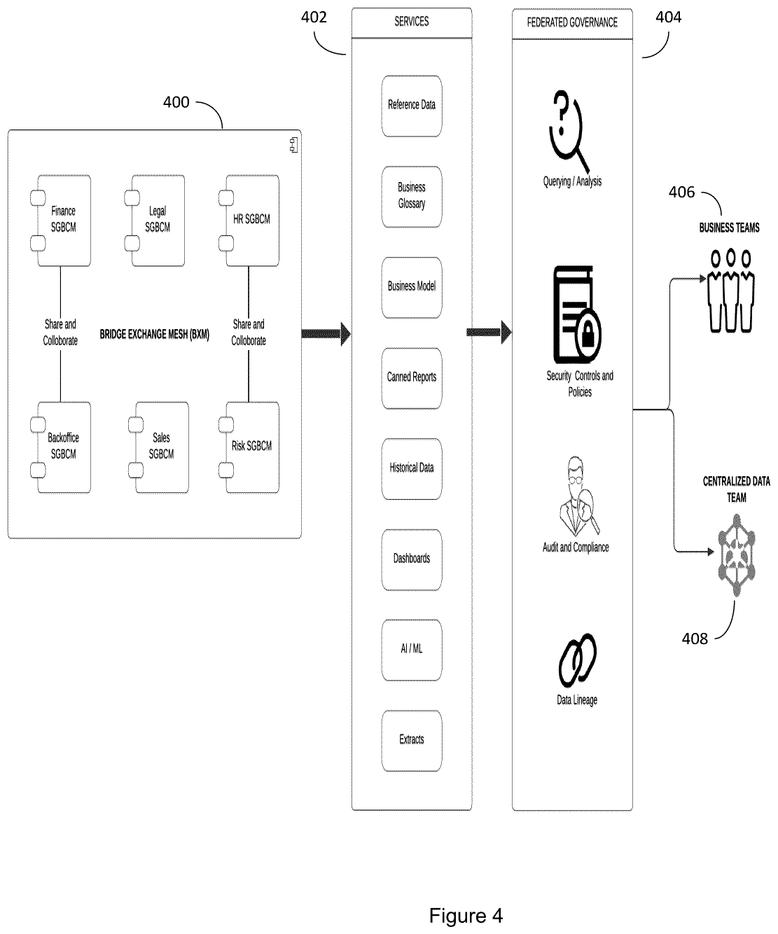

Turning now to FIG. 4, presents a services diagram of the Bridge Exchange Mesh (BMX) consistent with certain embodiments of the present invention is shown. At 400 a data mesh network installed within the system permits the collaboration of a plurality of semantic glossary-driven business conceptual modeling (sgbcm) platform, each semantic glossary-driven business conceptual modeling (sgbcm) platform is created from data sources specific to a particular portion of a business. In a non-limiting example, the semantic generation engine models may create business models for business units such as Finance, Legal, Human Resources, Backoffice, Sales, and Risk Management, among other business units. At 400 the business models created may be shared in a collaboration across a Bridge Exchange Mesh (BXM) network. 402 presents a set of business services shared across the organization, ensuring that business models adhere to the performance and compliance standards established by the business rules during their creation. These business services may include reference information, an optimized business glossary, a consolidated business model, standard reports to be generated routinely, historical business data lying horizontally within the data lake, operational dashboards for the user interface, AI and Machine Learning data models for use in business transactions, and extracts of business operational information. At 404 the created business models may be used to perform federated governance for the business as a whole by creating models for use in business queries and analysis, security controls and policies, audit and compliance to governmental and business regulations, and overall data usage for both internal and external users. These business models provide by the federated governance may be actively used by other business teams or departments at 406 and assist the centralized data team 408 in loading and maintenance of the data structures in data hub or the data mart upon which the business depends to both optimize and continue operations.

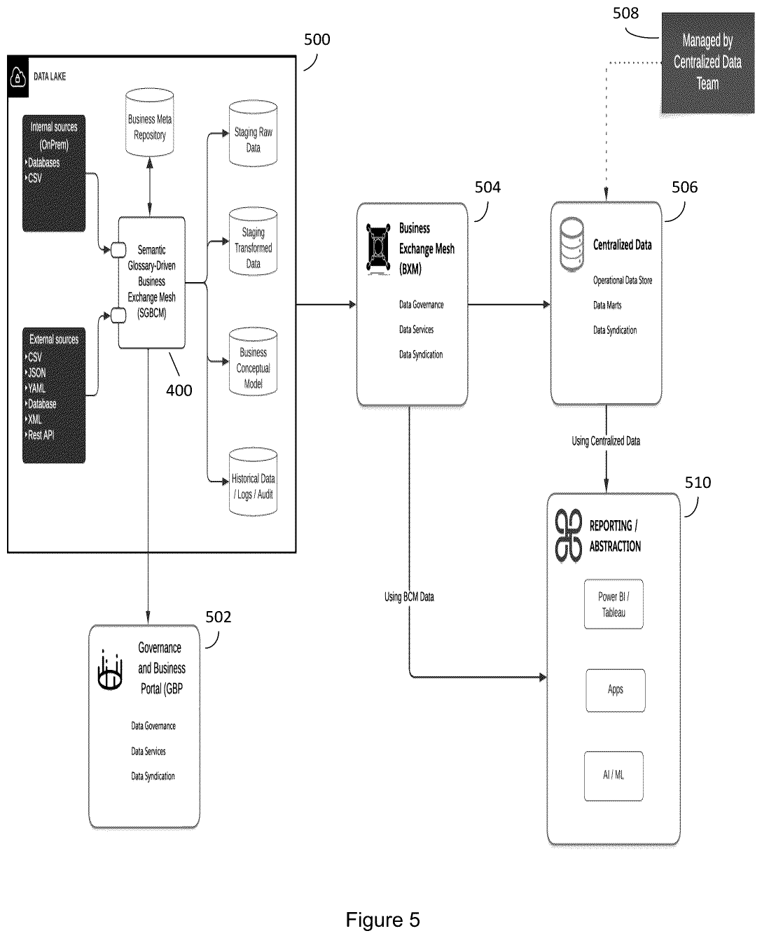

Turning now to FIG. 5, presents the system architecture diagram of the data platform, data governance and reporting consistent with certain embodiments of the present invention is shown. Data utilized in the creation and use of a plurality of business models may be maintained in a Data Lake at 500. The Data Lake 500 is a complex electronic storage data structure and storage architecture that permits the retention of a plurality of information in a defined set of data formats. For the Data Lake 500 utilized in the generation of one or more business models, data may be stored within the Data Lake 500 that is composed of internal (on premises) data sources that are in specified internal database formats and/or CSV formats, and external data sources that may be imported in CSV, JSON, YAML, XML Rest API, and/or specified databases. The internal and external data sources provide source meta data, along with the business rules is stored in the Business Meta Repository using the Governance and Business Portal (GBP) that is connected with the Semantic Glossary-Driven Business Exchange Mesh (SGBCM) platform at 400. The SGBCM utilizes the input data from the data sources and the business metadata repository to create a plurality of database structures comprising Staging Raw Data, Staging Transformed Data, Business Conceptual Model data, and a Historical Data/Logs/Audit data.

The SCBCM 400 utilizes the Governance and Business Portal (GBP) 502 to permit the system to provide data and glossary management, business rules and model management and collaboration/compliance management from the system to users. At 504 the Business Exchange Mesh (BXM) provides data and services for retention to the Centralized Data Repository 506 electronic storage element, which is managed and maintained by the Centralized Data Team 508. The BXM 504 also provides Business Conceptual Model information to the Reporting/Abstraction module 510. The Reporting/Abstraction module 510 also retrieves information from the Centralized Data Repository 506 to permit the creation and dissemination of business operational, training, and future data through Business tableaus, Apps, and Large Language Model (LLM) results from AI and/or Machine Learning algorithms. The Reporting/Abstraction module permits customer centric access to the business conceptual models and operational capabilities as the business operates in an ongoing basis.

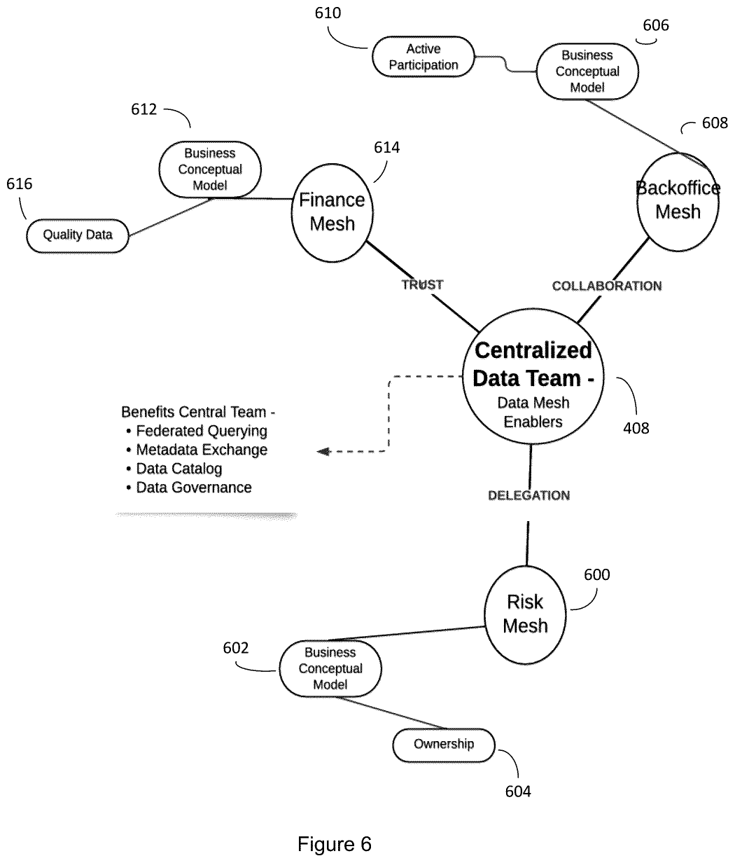

Turning now to FIG. 6, presents a mind map diagram of the hybrid data mesh benefits consistent with certain embodiments of the present invention is shown. The Centralized Data Team 408 is an enabler of the Data Mesh network operated by multiple business units or departments within the organization. The business conceptual model information the Centralized Data Team 408 receives from the different department sources of information permits operations such as federated querying, metadata exchange, an operational data catalog, and data governance, among other operational capabilities. In a non-limiting example, a business conceptual model based around risk assessment 602 may be created by the risk team for consumption by the Centralized Data Team 408 and thus providing a sense of ownership of the data to the risk team 604. The risk-based business conceptual model 602 will be owned and maintained by the risk team within the risk mesh 600

In another non-limiting example, a business conceptual model based around back office operations 606 may be created by the back office team for consumption by the Centralized Data Team 408 that allows active participation of the back office team in their data initiatives 610. The back office business conceptual model 606 will be owned and maintained by the back office team within the back office mesh 608 of the mesh network that permits collaboration among other business units and the centralized data team.

In another non-limiting example, a business conceptual model based around business finance operations 612 may be created by the back office team for consumption by the Centralized Data Team 408 containing specific business quality rules maintained and owned by the finance team 616. The business finance business conceptual model 612 will be owned and maintained by the finance team within the finance mesh 614 of the mesh network to permit collaboration among other business units, the centralized data team and optimization of business operations with regard to financial health of the organization.

In an embodiment, the system and method of the instant innovation is non-rigid through its use of a data model built dynamically using a business glossary and metadata. The instant innovation requires no development overhead like table creation/migration, code deployment, scheduling etc. The instant innovation permits dynamic model versioning and metadata captured internally via workflows.

In an embodiment, the instant innovation cases data exploration for casual or novice users. The instant innovation uses a low/no code environment allowing users to explore and experiment with data. This functionality allows users to understand proprietary data, implement DQ rules and improve data quality over time. The instant innovation allows the implementation of rapid data analytics, which in turn allows users to see different facets of their data. User data can eventually be productionalized and used in a traditional OLTP, Data Lake, or Data Warehouse. The instant innovation complements existing systems and makes quality data ingestion easier.

In an embodiment, the instant innovation may store data in serverless databases like Embedded, file-based RDBMS which may themselves become part of the file system. This allows data to be horizontally scaled. In an embodiment, the historical data for each as-of-date may be distributed across multiple folders. Consequently, the system allows storing and reading data from multiple versions of the same model.

While certain illustrative embodiments have been described, it is evident that many alternatives, modifications, permutations and variations will become apparent to those skilled in the art in light of the foregoing description

We claim:

1. A system for data management utilizing a business conceptual data model, comprising:
a data processor receiving a plurality of data files from a plurality of data sources internal and external to said data processor;
the data processor receiving a set of source data rules for data management from a Subject Matter Expert (SME);
the data processor receiving a business glossary of customized data definitions from the SME;
the data processor, under direction of said SME, linking the received source data rules to the business glossary;
the data processor further comprising a business conceptual model engine process module to create a business conceptual model where said business conceptual module guides the data analysis of said plurality of data files;
where the metaware process module derives business operation insights from the data analysis; and
said data processor utilizes said derived business operation insights to optimize business governance methods and optimize services provided to clients of the business.

2. A system according to claim 1, further comprising a semantic meta generation engine for creating a semantic layer of data definitions.

3. A system according to claim 2, where the semantic layer is transmitted to a business conceptual model generation engine to process incoming data for inclusion in the creation of said business conceptual model.

4. A system according to claim 1, further comprising a governance and business portal within said data process.

5. A system according to claim 4, where said governance and business portal is operative to capture business data sources, define a business data definition glossary, define business and data quality rules, and standardize and manage reference data under the guidance of said SME.

6. A system according to claim 1, further comprising a bridge exchange mesh network operative to foster sharing and collaboration between mesh nodes operative within and connected to said bridge exchange mesh network.

7. A system according to claim 1, where said business governance optimization further comprises optimizing data analysis, security controls and policies, audit and compliance, and data lineage and transmits optimized business processes to a centralized data team within said business.

8. A system according to claim 1, further comprising a centralized data electronic storage structure to maintain an operational data store for the business, provide one or more data marts for client data access, and provide data syndication for internal and external clients and stakeholders.

9. A system according to claim 1, further comprising a reporting module within said data processor to permit business tableau creation and use, provide access to one or more applications operative within said data processor, and provide for access to AI and/or Machine Learning training data models.

10. A system according to claim 1, further comprising a plurality of mesh nodes on said mesh network dedicated to business operation departments including finance, backoffice, risk, and operations to provide for trust and collaboration among business units and the centralized data team connected through said mesh network.
